(19) United States
(12) Patent Application Publication
(10) Pub. No.: US 2023/0193053 A1
(43) Pub. Date: Jun. 22, 2023

(54) PIGMENTED PASSIVE RADIATIVE COOLING COATING

(71) Applicant: PALO ALTO RESEARCH CENTER INCORPORATED, Palo Alto, CA (US)

(72) Inventors: Stephen Matthew Meckler, Boulder, CO (US); Eugene S. Beh, Menlo Park, CA (US); Sepehr M. Tehrani, Toronto (CA)

(21) Appl. No.: 18/109,954

(22) Filed: Feb. 15, 2023

Related U.S. Application Data
(63) Continuation-in-part of application No. 17/496,528, filed on Oct. 7, 2021.

(51) Int. Cl. C09D 5/22; C09D 5/33; C09D 5/02; C09D 125/14; C09D 133/06

(52) U.S. Cl. CPC C09D 5/22; C09D 5/004; C09D 5/022; C09D 125/14; C09D 133/062; B82Y 20/00

(57) ABSTRACT

A radiative cooling composition comprises a first component having >55% reflectance in a wavelength range of 0.2 to 2.5 μm and a second component having >0.85 peak thermal emissivity for at least one wavelength in a range of 4-35 μm. A third pigmented component of the composition is configured to emit at least a fraction of absorbed energy, and in certain embodiments the pigmented component comprises at least one phosphor.

### TECHNICAL FIELD

This disclosure relates generally to a pigmented coating that cools a surface by passive radiative cooling.

### BACKGROUND

Cooling can be achieved by active cooling or passive cooling. Active cooling involves the consumption of energy to cool an object such as by paying for external energy to supply an air conditioning system. In contrast, passive cooling occurs naturally with no additional costs or energy from an external source. Radiative cooling occurs when an object loses heat by thermal radiation such as electromagnetic radiation generated by thermal motion of charged particles in the object, and passive radiative cooling refers to an object losing heat by thermal radiation to an external thermal sink without the consumption of energy.

All objects constantly emit and absorb energy and undergo cooling when the net energy flow is outward, or experience heat gain when the net energy flow is inward. For example, passive radiative cooling of buildings typically occurs during the night when long-wave radiation from the sky absorbed by the building is less than the long-wave infrared radiation emitted by the building. Conversely, during the daytime, solar radiation reaching and absorbed by the building may be greater than the emitted long-wave infrared radiation such that there is a net flow into the building.

Passive radiative cooling may be improved by using materials or coatings that increase the amount of energy emitted from a surface and/or reduce the amount of energy absorbed by the surface, where the surface may enclose the desired volume to be cooled. Such coatings include passive radiative cooling paints, also known as self-cooling paints. Currently available passive radiative cooling paints are white in color because the addition of a pigment or dye would cause the paint to absorb radiation and interfere with the radiative cooling property of the paint. Embodiments discussed herein are directed to pigmented passive radiative coatings that achieve a cooling rate comparable to those of white coatings.

### SUMMARY

Embodiments described herein are directed to a radiative cooling composition. The composition comprises a first component having >55% reflectance in a wavelength range of 0.2 to 2.5 μm and a second component having >0.85 peak thermal emissivity for at least one wavelength in a range of 4-35 μm. A third pigmented component of the composition is configured to emit at least a fraction of absorbed energy, and in certain embodiments the pigmented component comprises at least one phosphor.

Other embodiments are directed to a passive radiative cooling apparatus. The apparatus comprises a substrate with a first component disposed on the substrate having >55% reflectance in a wavelength range of 0.2 to 2.5 μm. A second component has >0.85 peak thermal emissivity for at least one wavelength in a range of 4-35 μm. A third pigmented component comprising at least one of a phosphor and quantum dot is configured to emit at least a fraction of absorbed energy. The first, second, and third components are distributed in one or more layers on the substrate. In certain embodiments, the third pigmented component may be mixed into a layer with the second component or disposed in a layer over the second component.

Further embodiments are directed to a method. The method includes providing a substrate and providing a composition. The composition comprises a first component having >55% reflectance in a wavelength range of 0.2 to 2.5 μm, a second component having >0.85 peak thermal emissivity for at least one wavelength in a range of 4-35 μm, and a third pigmented component at least one of a phosphor and quantum dot configured to emit at least a fraction of absorbed energy. The method further includes depositing the composition on the substrate to form a passive radiative coating on the substrate.

The above summary is not intended to describe each disclosed embodiment or every implementation of the present disclosure. The figures and the detailed description below more particularly exemplify illustrative embodiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The discussion below refers to the following figures, wherein the same reference number may be used to identify the similar/same component in multiple figures. However, the use of a number to refer to a component in a given figure is not intended to limit the component in another figure labeled with the same number. The figures are not necessarily to scale.

FIG. 1 is an illustration of a coating of a passive radiative cooling composition in accordance with certain embodiments;

FIG. 2A illustrates a cross-section of a passive radiative coating comprising at least two layers in accordance with certain embodiments;

FIG. 2B illustrates a cross-section of a passive radiative coating comprising at least three layers in accordance with certain embodiments;

FIG. 2C illustrates a cross-section of a passive radiative coating comprising a plurality of layers in accordance with certain embodiments;

FIG. 3A is a color photograph of a non-pigmented passive radiative coating;

FIG. 3B is a color photograph of a pigmented passive radiative coating in accordance with certain embodiments; and

FIG. 4 is a graph illustrating the temperatures of various coatings as a function of the time of day.

### DETAILED DESCRIPTION

Passive radiative cooling coatings, such as paints, are white to maximize their cooling performance, particularly with respect to the open sky. These radiative cooling coatings can achieve a cooling rate of up to 10° C. (18° F.) below the ambient air temperature by combining high solar reflectance with high infrared (IR) emittance in the atmospheric (or sky) transparency window (i.e., 8-13 μm). The ability to add color to radiative cooling coatings would broaden the types of objects/features where the coatings could be applied. However, traditional absorptive pigments and dyes (e.g., non-flourescent absorptive pigments/dyes) intrinsically degrade cooling performance as energy from incident photons is converted into heat. Scalable, affordable, and paintable solutions to add color while minimally impacting the performance of a white passive radiative cooling coating expands the applications for such coatings.

Previous approaches to introduce color to passive radiative cooling components are expensive, not amenable to coatings such as paints, and/or do not efficiently reject heat from solar radiation. For example, dyes and pigments have been identified that may achieve a desired appearance with minimal solar absorption. They tend to have minimal near-infrared absorption, as this solar absorption increases temperature without producing a color change visible to humans. However, the absorbance in the visible wavelengths (e.g., 380-700 nm) still substantially heats the substrate. Other approaches involve imparting structural color, for example, by using stacked Bragg gratings, metamaterials, etc. as an alternative, or supplement, to coatings. These approaches are generally very expensive.

Described herein, pigmented passive radiative coating compositions have the same ease of incorporation into a coating, or paint, as any other dye or pigment. But the ceiling for improving, or optimizing, the perceived color to efficiency loss ratio is much higher. This is done by incorporating a class of materials known as phosphors. Pigments and dyes known as phosphors add color to a passive radiative cooling coating, such as a paint. Phosphors absorb a photon (typically in the ultraviolet spectrum) and emit a photon at lower energy. As used herein, ultraviolet (UV) radiation is defined as having a wavelength less than 380 nm (e.g., 10-380 nm), visible light is defined as having a wavelength in a range of 380-700 nm, and infrared (IR) radiation is defined as having a wavelength above 700 nm (e.g., 700-1,000,000 nm). Thus, the energy lost to heat is not the full energy of the incident photon but rather a fraction of it. Specifically, the amount of energy lost to heat is the difference between the energy of the incident photon and that of the fluoresced photon. The operation of the pigmented passive radiative coating is described further below.

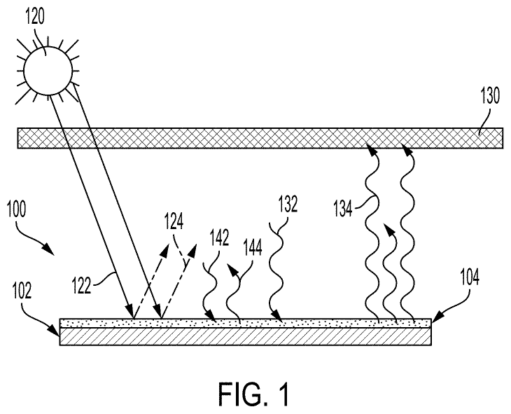

FIG. 1 illustrates an apparatus 100 including a coating 104 of a radiative cooling composition on a substrate 102, in accordance with various embodiments. The substrate 102 may comprise one or more of metal, ceramic, plastic, composite, stationary parts, moving parts, etc. In certain embodiments, the substrate 102 may be one or more of aluminum, steel, galvanized steel, carbon fiber resin, a roof tent, a flexible tarp, an upper layer of a roof structure, an outer surface of a vehicle, an interior surface (e.g., cabin) of a vehicle, etc. For example, the substrate 102 may be any object used in building applications and/or construction; outdoor electronics; road paint; vehicles including automobiles, trains, and planes; tents and temporary construction; power plant cooling; pumped water cooling (e.g., dissipate heat from the water to the sky 130 so that Tout of the water is less than Tin); umbrellas; blankets; etc.

In certain embodiments, and used herein as an example, the substrate 102 may be a roof of a building. A coating 104 is applied to the roof substrate 102 to cool the roof (e.g., the coating 104 is a cool roof coating, where a “cool roof” is a roof that has been designed to reflect more sunlight and absorb less heat than a standard roof). The coating 104 may include a reflective component that reflects sunlight and may also protect the substrate 102 (e.g., roof surface) from ultraviolet (UV) light and/or chemical damage. In certain embodiments, the coating 104 may also provide water protection and/or restorative features.

The coating 104 is a pigmented radiative cooling composition that is applied to the substrate 102 in a single layer. The pigmented radiative cooling composition may be applied to, or deposited on, the substrate 102 in the form of a paint (e.g., sprayed, brushed, rolled, dipped, doctor bladed, etc.) to form the coating 104. The components of the pigmented cooling composition may be deposited on the substrate in a single step as an existing composition or they may be applied in two or more steps to form the composition on the substrate. When the components are deposited in two or more steps, the components may each be deposited separately, or they may be deposited in various combinations in each step. The pigmented radiative cooling composition provides solar reflectance and infrared emissivity in a single layer that can be applied, e.g., sprayed on, as coating 104. The pigmented radiative cooling composition may include a binder and a solar reflector material (e.g., solar reflector particles) embedded in the binder (e.g., the binder binds solar reflector material together).

The coating 104 can either be a broadband thermal emitter (i.e. provides thermal emission at all wavelengths >4 μm) or a selective emitter (e.g., emits thermal radiation in the atmospheric transparency window (i.e., 8-13 μm)). In both cases, the coating 104 cools by emitting more thermal energy (thermal emission 134) to its surroundings (e.g., the sky, which performs as a cold sink, 130) than the thermal energy (thermal emission 132) that the coating 104 absorbs from the sky 130. As used herein, the term “sky” refers to Earth's atmosphere and the vacuum of space beyond the atmosphere. The application or type of use may be a factor in determining whether the coating 104 is developed as a broadband or selective thermal emitter. For example, a broadband thermal emitting coating may be preferred in applications where the underlying substrate is hotter than ambient temperature (e.g., a coating on a roof of a server farm that produces a lot of heat). In applications where sub-ambient temperatures are likely to be reached (e.g., a coating on a roof of a typical residential home), a selective thermal emitting coating may be preferred.

A broadband thermal emitter may maximize the cooling power of the coating 104 and may achieve a temperature of about 10° C. below ambient temperature. However, a selective emitter may maximize the temperature difference relative to ambient air temperature and may achieve a temperature of about 60° C. below ambient (e.g., temperature difference may depend on amount of energy loss due to convection, conduction, and radiation). Selective emission may not be needed when the temperature of the coating 104 is 10° C. below ambient temperature, or lower, and selective emission may be needed when the temperature of the coating 104 is between ambient temperature and 10° C. below ambient temperature.

The composition includes two or more polymers (e.g., a first polymer and a second polymer). In certain implementations, the two or more polymers are substantially water insoluble (e.g., once dried or cured are practically not soluble in water, about greater than 10,000 mL water is needed to dissolve 1 g of the two or more polymers that are practically water insoluble). In certain embodiments, the two or more polymers are water insoluble.

The two or more polymers are also substantially non-absorbing (e.g., solar absorbance of the polymers is less than 0.7 when the coating 104 has a thickness of at least 1 millimeter (mm)) to light having wavelengths in a solar spectrum (e.g., 200-4000 nm), 400-700 nm, 450-650 nm, etc.). In certain embodiments, the two or more polymers have emissivity peak values greater than 0.85 at wavelengths between 4 and 35 μm. In certain embodiments, the two or more polymers have emissivity peak values greater than 0.85 at wavelengths between 8 and 13 μm. Two or more of the emissivity peak values are substantially non-overlapping (e.g., a first emissivity peak value of a first polymer is at a first wavelength and a second emissivity peak value of a second polymer is at a second wavelength which is substantially different from the first wavelength). A net emissivity of the two or more polymers is greater than emissivity of any one of the two or more polymers alone, that is the aggregate emissivity is increased in the range of 4-35 μm. For example, a net emissivity of the first polymer and the second polymer at a third wavelength between 4 and 35 μm is greater than emissivity of either of the first polymer or the second polymer alone at the third wavelength.

Example materials for the two or more polymers may include ethyl cellulose, poly ethyl methacrylate (PEMA), poly methyl methacrylate (PMMA), polyvinyl butyral (PVB), cellulose acetate, polyethylene, polypropylene, polyethylene terephthalate (PET), polyethylene naphthalate (PEN), polyesters, and polycarbonates, where the first polymer of the two or more polymers is different from the second polymer. The two or more polymers may also incorporate ultraviolet absorber additives that absorb UV radiation (e.g., wavelengths <380 nm). Example ultraviolet absorbers include hydroxybenzophenone, hydroxyphenylbenzotriazole, titanium dioxide, benzotriazoles, and hydroxyphenyltriazines.

One, both, or more of the two or more polymers may also act as a mechanical binder for the components of the coating 104. As used herein, a coating component can be a single material or multiple materials added to achieve a particular function in the coating formulation. In other embodiments, a separate component is added as a binder for the coating components. In certain embodiments, the components acting as a binder have a high spectral emittance (e.g., emissivity peaks) at wavelengths where infrared radiation occurs for a blackbody at a temperature near 300 Kelvin (K) (e.g., wavelengths of 4-35 μm). In certain embodiments, the binder in the coating 104 has a high spectral emittance at wavelengths for which the atmosphere is transparent (i.e., 8-13 μm). This creates an imbalance between thermal radiation emitted by the coating 104, and that emitted by the atmosphere and absorbed by the coating 104. The imbalance provides a net cooling of the binder components, coating 104, substrate 102, and apparatus 100.

To further provide cooling, the coating 104 reflects rays 122 from the sun 120 (i.e., wavelengths in the solar spectrum of 0.3-2.5 μm) to produce reflected sun rays 124. In certain embodiments, the sun rays 122 are scattered by the two or more polymers. In other embodiments, the sun rays 122 are propagated through the two or more polymers and scattered by a solar reflector material. In further embodiments, a first portion of the sun rays 122 are scattered by the two or more polymers and a second portion of the sun rays 122 are propagated through the two or more polymers and scattered by the solar reflector material, leading to a solar reflectance of coating 104 that is higher than 0.95.

The solar reflector material reflects wavelengths in the solar spectrum shown as sun rays 122. The solar reflector material may reflect solar radiation (wavelengths of 0.3-2.5 μm) with an average solar reflectance that is higher than 0.95. The heat input due to absorbed solar radiation is less than the heat loss due to emitted thermal radiation thus resulting in a net heat loss for the coated object. For example, for a typical solar illumination of 900 W/m², a solar reflectance of the coating 104 equal to 0.95 results in heating of the object at a power density of 45 W/m². The net cooling power from thermal emission (thermal radiation power density emitted by the apparatus 100 minus thermal radiation power density absorbed from the atmosphere at a surface temperature, and an ambient air temperature of 30° C.) is about 100 W/m². In this case, the apparatus temperature is reduced due to the imbalance (e.g., net power into the object is 45 W/m²−100 W/m²=−55 W/m²).

In certain embodiments, the solar reflector material is a pigment that can be used in paint. In certain implementations, the solar reflector material includes particles of barium sulfate (BaSO₄, barite, blanc fixe). Using BaSO₄ in the coating 104 may provide a solar reflectance of the coating 104 of up to 97%. BaSO₄ has high spectral emissivity at 8.4, 8.9, and 9.3 μm, and contributes to infrared radiation (IR) emission in the atmospheric transparency window of 8-13 μm. In an example embodiment, at least half of the particles of BaSO₄ are smaller than 2 μm, and in another example embodiment, at least half of the particles of BaSO₄ are no larger than 5 μm. In other example embodiments, at least half of the particles of BaSO₄ are not smaller than 0.2 μm, and in a further example embodiment, at least half of the particles of BaSO₄ are not smaller than 0.1 μm. In example embodiments, the particles of BaSO₄ have a mean particle size (volume) distribution (D50(volume)) from about 0.1 to about 5 μm, and in other embodiments from about 0.2 to about 2 μm. In an example embodiment, 0.0% of the particles of BaSO₄ fall below 0.1 μm, and in another embodiment, 0.0% of the particles of BaSO₄ are above 5 μm.

The solar reflector material particles may have a distribution of sizes and morphologies (e.g., related to the method of manufacture). In certain embodiments, the solar reflector material includes one or more of spherical particles, flake particles, or elongated particles. In another embodiment, the solar reflector material comprises particles of polytetrafluoroethylene (PTFE). Example materials for the solar reflector material include one or more of TEFLON™, PTFE, BaSO₄, PTFE, zinc oxides (ZnO), aluminum oxides (Al₂O₃, alumina), magnesium oxides (MgO, magnesia), titanium dioxides, lead-containing compounds, strontium sulfides, zinc sulfides, antimony oxides, bismuth tungstate, bismuth oxychloride, tin oxides, bismuth subnitrate, calcium carbonate, mica, talc, lithopone, silicon oxides, calcium metasilicate, and lead titanate.

When the above components comprise a passive radiative cooling composition, the color of the coating 104 is substantially white. To form a colored passive radiative cooling coating 104, the passive radiative cooling composition further includes a pigmented component. A pigmented component is any component producing a non-white color in the visible light spectrum, with the color coming from a pigment, dye, other colored material, or a combination thereof. While color, or colored components, in a coating may be commonly understood to equate to absorbed energy in the form of heat, the pigmented component in the passive radiative cooling compositions described herein absorbs photons at the wavelength of absorbed energy 142 and emits photons, and the associated energy, in a wavelength in a different range of the spectrum 144. The pigmented component is selected based on its ability to absorb energy in a first wavelength range and emit energy in a second, lower wavelength range. For example, the pigmented component may absorb energy in the ultraviolet or visible ranges of the electromagnetic spectrum 142 and emit energy in the visible, or lower energy visible wavelength, range of the electromagnetic spectrum 144. The pigmented component may also be selected based on its ability to absorb energy in the visible range of the electromagnetic spectrum 142 and emit energy in the infrared range of the electromagnetic spectrum 144. By either increasing or decreasing photon flux reflected or emitted from the composition at certain wavelengths of light, the color of the coating will change from white to some other desired color. Because only a fraction of the solar energy absorbed by the pigmented component is converted to heat, the temperature of the composition will be lower than if the pigmented component changed the composition color by absorption alone. In certain embodiments, the pigmented component may include at least one of a phosphor and/or a quantum dot.

The phosphors and/or quantum dots introduced to the passive radiative cooling composition are selected based on the desired color and/or chemistry for the coating application. For example, inorganic phosphors such as materials containing calcium sulfide with strontium sulfide, zinc sulfide, bismuth, copper, cadmium sulfide, strontium aluminate, europium, oxides, nitrides, oxynitrides, sulfides, selenides, halides, silicates, zinc, cadmium, manganese, aluminum, silicon, or various rare-earth metals may be used. Inorganic phosphors may be used when low cost, durability, and/or long lifetime are desired for the coating application. Quantum dots, such as graphene quantum dots, cadmium selenide-containing quantum dots, zinc selenide-containing quantum dots, selenide-containing quantum dots, telluride-containing quantum dots, sulfide-containing quantum dots, core-type quantum dots, core-shell quantum dots, and alloyed quantum dots may also be used. Quantum dots may be used when precise control over the absorption and emission wavelengths is desired for the coating application. The size of the quantum dot may also influence the color of the resulting coating 104. For example, larger quantum dots have a larger spectrum shift toward red and smaller quantum dots have a spectrum shift toward blue. Organic and organometallic phosphors may also be used.

In some embodiments, materials absorb multiple lower-energy photons for every higher-energy photon emitted, such as with upconverting nanoparticles or materials capable of second-harmonic generation or two-photon excited fluorescence. In these cases, color can be produced when absorption is in the infrared wavelengths and emission in the visible wavelengths, when absorption is in the visible wavelengths and emission is at higher-energy visible wavelengths, and/or when absorption is in the visible wavelengths and emission is in the ultraviolet wavelengths.

In some embodiments, when the pigmented component is a quantum dot, the particle diameter of the pigmented component is less than 5 nm, less than 10 nm, less than 20 nm, less than 50 nm, less than 100 nm, or less than 500 nm. In some embodiments, when the particle is an inorganic phosphor, the particle diameter of the pigmented component is less than 500 nm, less than 1 μm, less than 2 μm, less than 5 μm, less than 10 μm, between 1-2 μm, between 2-5 μm, or between 5-10 μm. The standard deviation, in some embodiments, of the particle diameter is less than 5% of the particle diameter, less than 10% of the particle diameter, or less than 25% of the particle diameter. In certain embodiments, the surface of the particles of the pigmented component is coated with a material or organic functional group, for example, to enhance the dispersion in the composition. The surface material may include one or more of polymers, carboxylic acid groups, oleic acid, oleate, and amines. In certain embodiments, the phosphorescence efficiency is greater than 5%, greater than 10%, greater than 25%, greater than 50%, greater than 85%, or greater than 90%. In certain embodiments, the internal quantum efficiency of the phosphorescence is greater than 5%, greater than 10%, greater than 25%, greater than 50%, greater than 85%, or greater than 90%

Phosphors and/or quantum dots can be incorporated into the radiative cooling composition discussed above while maintaining the cooling properties of the composition. In some embodiments, the cooling properties lower the temperature of the coating below ambient temperature. In other embodiments, the cooling properties lower the temperature below the temperature of another coating achieving the same perceived color but with traditional absorptive pigments and/or dyes. The above composition is modified by replacing a portion of the reflective material with an amount of pigmented component. In certain embodiments, the formulation comprises 2.5% by volume of a pigmented component (e.g., red phosphor) and 97.5% by volume of the white composition (e.g., two or more polymers and a reflective component, where the reflective component is white and the polymers are generally colorless). In another embodiment, the formulation comprises 1.3% by mass of a pigmented component (e.g., red phosphor) and 97.5% by mass of the white composition (e.g., two or more polymers and a reflective component, where the reflective component is white and the polymers are generally colorless). In other embodiments, the formulation may comprise up to 65% by mass of the third pigmented component. Due to the wavelength shifting of the pigmented component, addition of the pigmented component does not substantially alter the performance of the coating 104, and the pigmented passive radiative cooling composition maintains a temperature below ambient temperature when exposed to the sky.

The coating 104 may also include titanium dioxide (TiO₂) embedded in the binder. In certain embodiments, the TiO₂ is a separate layer on the coating 104. The TiO₂ may perform photocatalytic degradation of particles, gases, and pollutants that would otherwise result in increased solar absorbance and decreased solar reflectance. In certain embodiments, the pigmented radiative cooling composition may include less than about 1% by volume of TiO₂, about 5-94% or 55-75% by volume of BaSO₄, about 0.01-70% or 0.5-5% by volume pigmented component, and about 6-60% or 20-35% by volume binders. In embodiments without TiO₂, the pigmented radiative cooling composition may include about 5-94% or 55-75% by volume of BaSO₄, about 0.01-70% or 0.5-5% by volume pigmented component, and about 6-60% or 20-35% by volume binders. Some example embodiments include about 29%, 49%, 59%, 64%, 67%, 68%, 69%, or 79% BaSO₄ by volume, about 21%, 31%, or 41% binders by volume, and about 0.01%, 0.1%, 1%, 2%, 2.5%, 5%, 10%, 15%, 20%, 25%, 30%, or 50% pigmented component by volume.

In other embodiments, the pigmented radiative cooling composition may include less than about 1% by mass of TiO₂, about 5-97% or 80-95% by mass of BaSO₄, about 0.01-65% or 0.25-5% by mass pigmented component, and about 3-95% or 3-15% by mass binders. In embodiments without TiO₂, the pigmented radiative cooling composition may include about 5-97% or 80-95% by mass of BaSO₄, about 0.01-65% or 0.25-5% by mass pigmented component, and about 3-95% or 3-15% by mass binders. Some example embodiments include about 29%, 49%, 59%, 64%, 67%, 68%, 69%, 79%, 89%, 90%, or 95% BaSO₄ by mass, about 5%, 9%, 10%, 20%, 30%, or 40% binders by mass, and about 0.01%, 0.1%, 1%, 2%, 2.5%, 5%, 10%, 15%, 20%, 25%, 30%, 50%, or 65% pigmented component by mass.

The pigmented radiative cooling composition may also include a solvent that dissolves the two or more polymers. When the composition includes a solvent, the ratios of the components discussed above (e.g., polymer, BaSO₄, pigmented component, and/or TiO₂) remain the same with the addition of the solvent. In all cases, percent by mass or percent by volume of the cooling composition refers to the dry, solvent-free composition; that is, if a solvent is used in the deposition of the composition, it is not accounted for in the final composition mass or volume of the coating formulation. The solvent is selected based on its solvent strength as well as on its safety, boiling and flash points, and price. Example solvents include one or more of ethyl alcohol, BUTYL CARBITOL™, CARBITOL™, dimethylformamide, N-mehtylpyrrolidone, xylene, toluene, mineral spirits (e.g. mixture of aliphatic carbons), methylethyl ketone, methyl isobutyl ketone, butyl acetate, 1-methoxy-2-propylacetate, etc. In certain embodiments, the binder is in the form of an emulsion and water may be used as the liquid carrier. In certain embodiments the binder is an aqueous emulsion (also referred to as a water emulsion) such as a latex binder.

The binder of the pigmented radiative cooling composition may include a polymer emulsion including at least one of a first set of particles including the first polymer or a second set of particles including the second polymer. The binder may be a dispersion of one or more polymers in a solvent (e.g., water) in which the one or more polymers are not soluble or miscible. The binder (e.g., a polymer material) may be a water emulsion (e.g., incorporated as a water emulsion instead of as dissolved in an organic solvent). A binder that is a polymer emulsion may be used in environments requiring low volatile organic content (VOC) coating materials. The pigmented radiative cooling composition may also include a dispersion of particles (e.g., polymer binders, TiO₂, BaSO₄, dispersant, pigmented component, etc.) in water. In certain embodiments, the pigmented radiative cooling composition may include less than about 1% by volume of TiO₂, about 5-94% or 55-75% by volume of BaSO₄, about 0.01-70% or 0.5-5% by volume pigmented component, and about 6-60% or 20-35% by volume binders. In embodiments without TiO₂, the pigmented radiative cooling composition may include about 5-94% or 55-75% by volume of BaSO₄, about 0.01-70% or 0.5-5% by volume pigmented component, and about 6-60% or 20-35% by volume binders. Some example embodiments include about 29%, 49%, 59%, 64%, 67%, 68%, 69%, or 79% BaSO₄ by volume, about 21%, 31%, or 41% binders by volume, and about 0.01%, 0.1%, 1%, 2%, 2.5%, 5%, 10%, 15%, 20%, 25%, 30%, or 50% pigmented component by volume.

In other embodiments, the pigmented radiative cooling composition may include less than about 1% by mass of TiO₂, about 5-97% or 80-95% by mass of BaSO₄, about 0.01-65% or 0.25-5% by mass pigmented component, and about 3-95% or 3-15% by mass binders. In embodiments without TiO₂, the pigmented radiative cooling composition may include about 5-97% or 80-95% by mass of BaSO₄, about 0.01-65% or 0.25-5% by mass pigmented component, and about 3-95% or 3-15% by mass binders. Some example embodiments include about 29%, 49%, 59%, 64%, 67%, 68%, 69%, 79%, 89%, 90%, or 95% BaSO₄ by mass, about 5%, 9%, 10%, 20%, 30%, or 40% binders by mass, and about 0.01%, 0.1%, 1%, 2%, 2.5%, 5%, 10%, 15%, 20%, 25%, 30%, 50%, or 65% pigmented component by mass. The emulsion may include dispersant stabilized polymer particles having a particle size from about 10-500 nm dispersed in water.

The polymer particle emulsion is prepared by dissolving the one or more polymers in an organic solvent by mixing the one or more polymers in the organic solvent with a mechanical stirrer and heating as necessary to obtain a homogeneous polymer solution. Any solvent that dissolves the one or more polymers and that is either not miscible or has relatively limited miscibility with water is suitable for the purpose of fabrication of the emulsion. About 10% by volume of NH₄OH is added to the polymer solution mixture drop-wise (e.g., drop by drop, dripping the NH₄OH into the polymer solution) and the mixture is stirred for up to fifteen minutes. Deionized water (e.g., about 3-5 times more deionized water than the volume of organic solvents) is slowly mixed with a pipette or with a pump for at least 1-5 hours. The mixture is poured into a glass pan, which is maintained in a fume hood overnight and is stirred by a magnetic stir-bar so that the solvent can evaporate off. Alternatively, the solvent can be removed by a conventional distillation process.

In certain embodiments, the coating 104 of pigmented radiative cooling composition further includes a hydrophobic material as a layer on the coating 104. Apparatus 100 may become dirty and accumulate dust, dirt, and/or debris over time which degrades the solar reflectance (e.g., a cool roof technology may drop 5-23% in solar reflectance over three years). Apparatus 100 must be cleaned and kept free of dust, dirt, and debris to maintain a high reflectance. The hydrophobic material (e.g., in or on the coating 104) allows the apparatus 100 to be kept clean and free of dust/debris to maintain a high reflectance over time (e.g., allows washing of the apparatus 100, prevents liquid accumulation, repels water, repels ice, etc.). The hydrophobic material is substantially non-absorbing of wavelengths from 0.3 to 2.5 μm. Example hydrophobic materials include fluorinated silica nanospheres and nano-etched silica.

The term “polymer” or “polymeric material” include, but are not limited to, organic homopolymers, copolymers, such as for example, block, graft, random and alternating copolymers, terpolymers, etc., and blends and modifications thereof. The term “polymer” refers to all possible geometrical configurations of the material. These configurations include, but are not limited to, isotactic, syndiotactic, and atactic symmetries.

The binder or second component of the pigmented radiative cooling composition may include aqueous emulsions that include latex polymers to form a latex binder. The term “latex” refers to an emulsion (stable dispersion) of polymer particles (about 50-500 nanometers in diameter, for example) in water. Latex polymers used as binder resins (also referred to herein as “binders”) include those polymers polymerized from one or more suitable monomers. Typically, the binders are polymerized from one or more copolymerizable monoethylenically unsaturated monomers such as, for example, vinyl monomers and/or acrylic monomers.

Vinyl monomers suitable for use herein include any compounds having vinyl functionality, that is, ethylenic unsaturation, exclusive of compounds having acrylic functionality, for example, acrylic acid, methacrylic acid, esters of such acids, acrylonitrile and acrylamides. Preferably, the vinyl monomers are selected from the group consisting of vinyl esters, vinyl aromatic hydrocarbons, vinyl aliphatic hydrocarbons, vinyl alkyl ethers and mixtures thereof.

Suitable vinyl monomers include vinyl esters, such as, for example, vinyl propionate, vinyl laurate, vinyl pivalate, vinyl nonanoate, vinyl decanoate, vinyl neodecanoate, vinyl butyrates, vinyl benzoates, vinyl isopropyl acetates and similar vinyl esters; vinyl aromatic hydrocarbons, such as, for example, styrene, methyl styrene and similar lower alkyl styrene, chlorostyrene, vinyl toluene, vinyl naphthalene and divinyl benzene; vinyl aliphatic hydrocarbon monomers, such as, for example, vinyl chloride and vinylidene chloride as well as alpha olefins such as, for example, ethylene, propylene, isobutylene, as well as conjugated dienes such as 1,3 butadiene, methyl-2-butadiene, 1,3-piperylene, 2,3-dimethyl butadiene, isoprene, cyclohexene, cyclopentadiene, and dicyclopentadiene; and vinyl alkyl ethers, such as, for example, methyl vinyl ether, isopropyl vinyl ether, n-butyl vinyl ether, and isobutyl vinyl ether.

Acrylic monomers suitable for use herein include any compounds having acrylic functionality. Preferred acrylic monomers are selected from the group consisting of alkyl acrylates, alkyl methacrylates, acrylate acids and methacrylate acids as well as aromatic derivatives of acrylic and methacrylic acid, acrylamides and acrylonitrile. Typically, the alkyl acrylate and methacrylic monomers (also referred to herein as “alkyl esters of acrylic or methacrylic acid”) will have an alkyl ester portion containing from 1 to about 18, preferably about 1 to 8, carbon atoms per molecule.

Suitable acrylic monomers include, for example, methyl acrylate and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecyl acrylate and methacrylate, benzyl acrylate and methacrylate, isobornyl acrylate and methacrylate, neopentyl acrylate and methacrylate, and 1-adamantyl methacrylate.

Useful latex binders include an aqueous emulsion (also referred to as a water emulsion) of one or more of styrene and acrylate polymers. The latex binder may include a reaction product of one or more of acrylate and vinyl monomers. The latex binder may include a cross-linker (monomers having more than one reactive group). The latex binder may include a styrene acrylic copolymer. A useful latex binder includes a reaction product of styrene monomer, n-butyl acrylate monomer, and methacrylic acid.

Useful latex binders have 90 to 100% of the total monomers forming the latex binder being styrene and acrylate monomers. Useful latex binders have 95 to 100% of the total monomers forming the latex binder being styrene and acrylate monomers. Useful latex binders have 99 to 100% of the total monomers forming the latex binder being styrene and acrylate monomers.

Useful latex binders include styrene present from 0 to 60% wt, or from 1 to 60% wt or from 10 to 50% wt, or from 20 to 50% wt, or from 30 to 50% wt, of total monomers forming the latex binder. Useful latex binders include acrylate present from 30 to 100% wt, or from 40 to 99% wt, or from 50 to 90% wt, or from 50 to 70% wt, of total monomers forming the latex binder.

Useful latex binders include styrene present from 10 to 50% wt of total monomers and acrylate present from 90 to 50% wt of total monomers. Useful latex binders include styrene present from 30 to 50% wt of total monomers and acrylate present from 70 to 50% wt of total monomers.

One useful latex binder is formed by combining: 58% deionized water, 15% styrene, 20% n-butyl acrylate, 4% methacrylic acid, 2% anionic surfactant, 0.6% chain transfer agent, and 0.4% initiator, (all by total weight percent of latex binder).

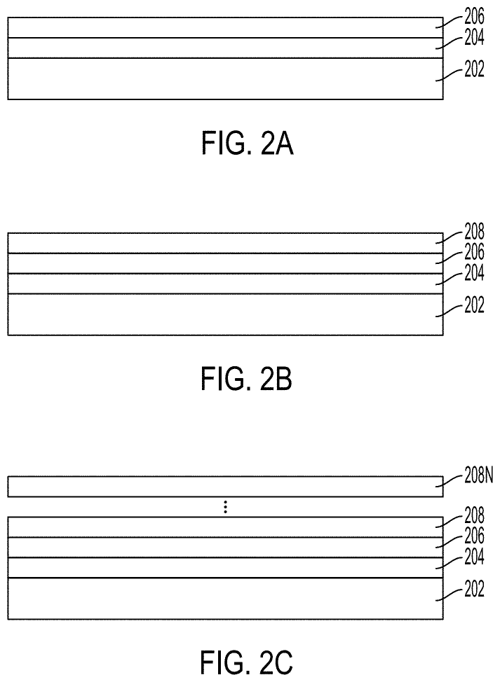

FIGS. 2A-C illustrate example combinations of a pigmented passive radiative cooling coating 204, similar to those discussed above, disposed on a substrate 202 and in combination with one or more additional layers. The one or more layers provide resistance to one or more of abrasion, ultraviolet radiation, water, and inorganic pollutants. The coating 204 with, or without, the one or more layers decreases its temperature below ambient temperature when the coating is exposed to the sky, regardless if solar illumination is present.

FIG. 2A illustrates the pigmented radiative cooling coating 204 disposed on a substrate 202 with a first layer 206 disposed on the coating 204, in accordance with various embodiments. As discussed above, the first layer 206 may comprise a protective material, including a material with hydrophobic properties. For example, the first layer 206 may comprise TiO₂ or a fluoropolymer (e.g., PTFE, PFA, FEP, ETFE, THB, etc.). Since layer 206 overlies the pigmented cooling coating 204, the fluoropolymer may be substantially non-absorbing of wavelengths in the range of 0.3-2.5 μm, meaning that the fluoropolymer may have measurable, yet insignificant, absorption in this wavelength range. In certain embodiments, a layer of fluoropolymer includes ETFE, where the ETFE may be a TEFZEL™ cover sheet that protects the coating 204 from environmental degradation. ETFE is hydrophobic and is transmissive to solar radiation. ETFE can decrease solar reflectance by about 0.28%, and ETFE is substantially non-absorbing of sunlight. In certain embodiments, the layer 206 includes components for resistance to one or more of abrasion (e.g., an anti-abrasion layer that protects coating 206 from degradation by sand or other particles), UV radiation, water, dust, and dirt.

In FIG. 2B, a hydrophobic material and a protective material may be disposed in separate layers on the pigmented passive radiative cooling coating 204. The hydrophobic material may comprise the first layer 206 or the second layer 208. For example, the first layer 206 may comprise a hydrophobic material or TiO₂. The second layer 208 may be at least one of a hydrophobic material, TiO₂, and a fluoropolymer (e.g., a TEFZEL™ cover sheet).

FIG. 2C illustrates that any number of layers may be disposed upon the pigmented passive radiative cooling coating 204. However, each of the layers 206 and 208-208N is substantially non-absorbing of wavelengths in the range of 0.3-2.5 μm so as to not inhibit the cooling performance of the coating 204. One or more of layers 206 and 208-208N may be a hydrophobic material, TiO₂, and a fluoropolymer. Each layer may be different or two or more layers may comprise the same material or same type of material (e.g., two different types of hydrophobic materials). In certain embodiments, the coating 204 has a thickness of 10-5,000 μm, and the overall thickness of the coating 204 plus any layers disposed thereon may be in the range of 10-10,000 μm. The thickness of the coating 204 may affect the quality of the color in the coating 204.

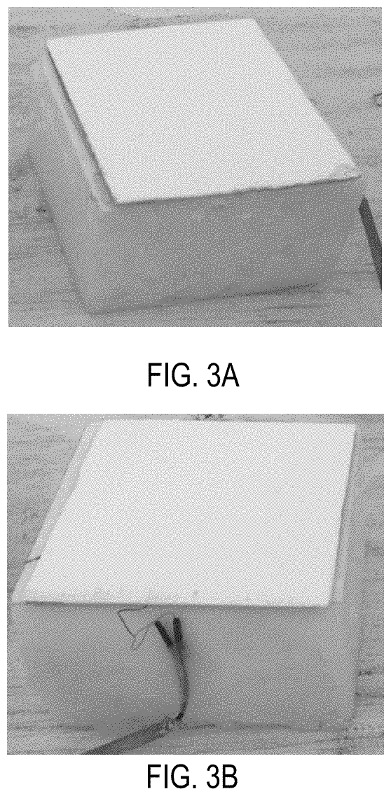

FIGS. 3A and 3B are color photographs that demonstrate the color achieved by introducing a pigmented component to a passive radiative cooling composition. FIG. 3A is a coating of a passive radiative cooling composition applied as a coating to a substrate where the composition includes two or more polymers and a reflective component, where the reflective component is white and the polymers are generally colorless. In FIG. 3B, a pigmented passive radiative cooling composition is applied as a coating on a substrate where the amount of reflective material from the composition of FIG. 3A was reduced by 2.5% by mass and replaced by a pigmented component, here a red phosphor. Varying the amount of pigmented component to replace reflective components in the overall cooling composition mixture controls the depth and shade of color in the coating, or paint. However, the addition of the pigmented component does not prevent the cooling composition from cooling below ambient temperature.

A coating as shown in FIG. 3A provides passive radiative cooling of 50-100 W/m² when cooling a surface at 30° C. at an ambient air temperature of 30° C., without input of water, air, refrigerant, electrical energy, mechanical energy or the need for complex structural features or cooling devices. A pigmented coating, as shown in FIG. 3B, is expected to have a slightly lower performance with the inclusion of the phosphors. For example, a coating as shown in FIG. 3B may provide passive radiative cooling of 0-100 W/m². In certain embodiments, the pigmented passive radiative cooling coating may not cool a substrate, but the coating will keep the heat of the substrate from increasing as compared with the same substrate coated with a typical paint of the same color.

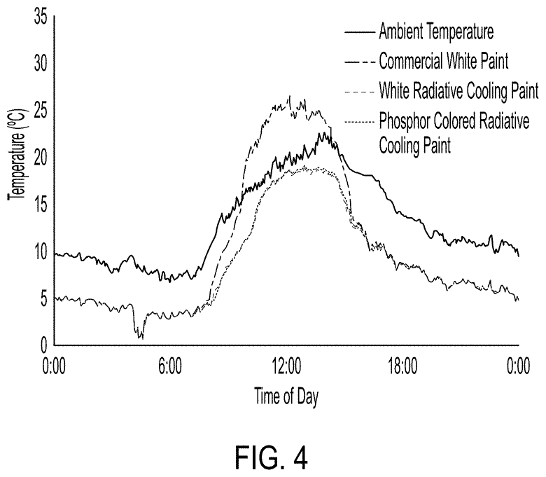

FIG. 4 is a graph illustrating the temperature as a function of the time of day for various substances. Specifically, the ambient temperature is compared with the temperature of a commercial white paint, a white passive radiative cooling paint, and a pigmented passive radiative cooling paint (e.g., the white passive radiative cooling paint with the addition of phosphor). As may be seen, each of the paints are throughout the night, and at the start of the day, below ambient temperature, but by noon, the commercial white paint temperature exceeds the ambient temperature. However, both white and pigmented radiative cooling paints remain below ambient temperature, and for the majority of the day, remain at least about five degrees below ambient temperature. The passive radiative cooling coatings (pigmented and not) described herein provide cooling properties both when not exposed to the sun and when exposed to the sun.

While typical pigments and dyes would undermine the operability of white passive radiative cooling compositions by increasing the absorption of atmospheric energy, and therefore temperature, the inclusion of phosphors or quantum dots to a passive radiative cooling composition can provide pigment without interfering with the cooling ability of the composition. The pigmented passive radiative cooling compositions described herein may be applied as a coating, or paint, in various applications to increase energy transfer and cooling of coated objects.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The foregoing description has been presented for the purposes of illustration and description. It is not intended to be exhaustive or to limit the embodiments to the precise form disclosed. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

What is claimed is:

1. A radiative cooling composition comprising:
a first component having >55% reflectance in a wavelength range of 0.2 to 2.5 μm;
a second component having >0.85 peak thermal emissivity for at least one wavelength in a range of 4-35 μm; and
a third pigmented component configured to emit at least a fraction of absorbed energy.

2. The radiative cooling composition of claim 1, wherein the third pigmented component comprises at least one phosphor.

3. The radiative cooling composition of claim 1, wherein the third pigmented component comprises quantum dots.

4. The radiative cooling composition of claim 1, wherein the composition comprises up to 65% by mass of the third pigmented component.

5. The radiative cooling composition of claim 1, wherein the third pigmented component is configured to absorb energy of an electromagnetic spectrum in at least one of ultraviolet and visible ranges of the electromagnetic spectrum and is configured to emit energy in the visible range of the electromagnetic spectrum.

6. The radiative cooling composition of claim 1, wherein the third pigmented component is configured to absorb energy in a visible range of the electromagnetic spectrum and emit energy in an infrared range of the electromagnetic spectrum.

7. The radiative cooling composition of claim 1, wherein the composition maintains a temperature below ambient temperature when exposed to the sky.

8. The radiative cooling composition of claim 1, wherein the composition maintains a temperature that is lower than a temperature of an otherwise identically colored composition comprising non-fluorescent absorptive pigments when exposed to the sky in identical circumstances.

9. The radiative cooling composition of claim 1, further comprising a fourth component configured to mechanically bind a mixture of the first, second, and third components.

10. The radiative cooling composition of claim 9, wherein the first and fourth components are the same material.

11. The radiative cooling composition of claim 9, wherein the second and fourth components are the same material.

12. The radiative cooling composition of claim 1, wherein the first component has >90% reflectance in a wavelength range of 0.2 to 2.5 nm.

13. The radiative cooling composition of claim 1, wherein the second component has >0.85 peak thermal emissivity for at least one wavelength in a range of 8-13 μm.

14. The radiative cooling composition of claim 1, wherein the first component comprises one or more of TEFLON″, polytetrafluoroethylene, barium sulfate, zinc oxides, aluminum oxides, magnesium oxides, titanium dioxide, lead-containing compounds, strontium sulfides, zinc sulfides, antimony oxides, bismuth tungstate, bismuth oxychloride, tin oxides, bismuth subnitrate, calcium carbonate, mica, talc, lithopone, silicon oxides, calcium metasilicate, and lead titanate.

15. The radiative cooling composition of claim 1, wherein the second component comprises one or more of ethyl cellulose, poly ethyl methacrylate (PEMA), poly methyl methacrylate (PMMA), polyvinyl butyral (PVB), cellulose acetate, polyethylene, polypropylene, polyethylene terephthalate (PET), polyethylene napthalate (PEN), polyesters, and polycarbonates.

16. The radiative cooling composition of claim 1, wherein the second component comprises latex binder.

17. The radiative cooling composition of claim 16, wherein the latex binder comprises an aqueous emulsion of one or more of styrene and acrylate polymers.

18. The radiative cooling composition of claim 17, wherein the latex binder comprises 30 to 50% wt styrene and 70 to 50% wt acrylate, based on total weight of monomers combined to form the latex binder.

19. A passive radiative cooling apparatus comprising:
a substrate;
a first component disposed on the substrate having >55% reflectance in a wavelength range of 0.2 to 2.5 μm;
a second component having >0.85 peak thermal emissivity for at least one wavelength in range of 4-35 μm; and
a third pigmented component comprising at least one of a phosphor or a quantum dot configured to emit at least a fraction of absorbed energy, where the first, second, and third components are distributed in one or more layers on the substrate.

20. The apparatus of claim 19, wherein the first, second, and third components are mixed into a single layer.

21. The apparatus of claim 19, wherein the third pigmented component is mixed into a layer with the second component.

22. The apparatus of claim 19, wherein the first component is disposed in a first layer, the second component is disposed in a second layer, and the third pigmented component is disposed in a third layer.

23. The apparatus of claim 19, wherein the substrate maintains a temperature below ambient temperature when the apparatus is exposed to the sky.

24. The apparatus of claim 19, wherein the composition maintains a temperature that is lower than a temperature of an otherwise identically colored apparatus comprising non-fluorescent absorptive pigments when exposed to the sky in identical circumstances.

25. The radiative cooling composition of claim 19, wherein the second component is a latex binder comprising a reaction product of acrylate and vinyl monomers.

26. A method, comprising:
providing a substrate;
providing a composition comprising:
a first component having >55% reflectance in a wavelength range of 0.2 to 2.5 μm;
a second component having >0.85 peak thermal emissivity for at least one wavelength in a range of 4-35 μm; and
a third pigmented component comprising at least one of a phosphor or quantum dot configured to emit at least a fraction of absorbed energy; and
depositing the composition on the substrate to form a passive radiative coating on the substrate.

27. The method of claim 25, wherein the depositing comprises at least one of spraying, brushing, rolling, dipping, or doctor blading.

28. The method of claim 25, wherein the composition is deposited on the substrate in a single step.

29. The method of claim 25, wherein the first, second, and third components are deposited on the substrate in two or more steps.
